(19) United States
(12) Patent Application Publication
(10) Pub. No.: US 2012/0162059 A1
(43) Pub. Date: Jun. 28, 2012

(54) HANDWRITING INPUT DEVICE WITH CHARGER

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/040,242

(22) Filed: Mar. 3, 2011

(30) Foreign Application Priority Data
Dec. 27, 2010 (TW) 99145980

(51) Int. Cl. G09G 5/00

(52) U.S. Cl. 345/156

(57) ABSTRACT

A handwriting input device includes a hollow charger and a handwriting pen. The charger includes a number of first contacts and a connecting unit. The handwriting pen includes a number of second contacts, a communication unit, a light source to emit light, an optical sensor, and a microcontroller. When the charger is connected to an external electronic device through the connecting unit, and the handwriting pen is inserted into the charger to cause each second contact to be contacted with one first contact, the handwriting pen can obtain power from the external electronic device. When the charger is moved, together with the handwriting pen being charged, the optical sensor converts the light reflected from a reflective surface under the charger into the electrical signals. The microcontroller generates and transmits the cursor control signals or the track control signals to the external electronic device.

### BACKGROUND

1. Technical Field

The present disclosure relates to handwriting input devices and, particularly, to a handwriting input device with a charger.

2. Description of Related Art

Handwriting pens can obtain power from an external electronic device, for example, a computer, through a USB cable. However, while charging the handwriting pens, the handwriting pens are not convenient for users to operate to control the external electronic device due to the USB cable.

### BRIEF DESCRIPTION OF THE DRAWINGS

The components of the drawings are not necessarily drawn to scale, the emphasis instead being placed upon clearly illustrating the principles of a handwriting input device with a charger. Moreover, in the drawings, like reference numerals designate corresponding parts throughout several views.

FIG. 1 is an exploded, perspective view of a handwriting input device in accordance with an exemplary embodiment.

FIG. 2 is a block diagram of a handwriting pen of FIG. 1.

FIG. 3 is an isometric view illustrating the handwriting pen of FIG. 1 employed as a mouse in accordance with a first embodiment.

FIG. 4 is another isometric view illustrating the handwriting pen of FIG. 1 employed as a mouse in accordance with a second embodiment.

### DETAILED DESCRIPTION

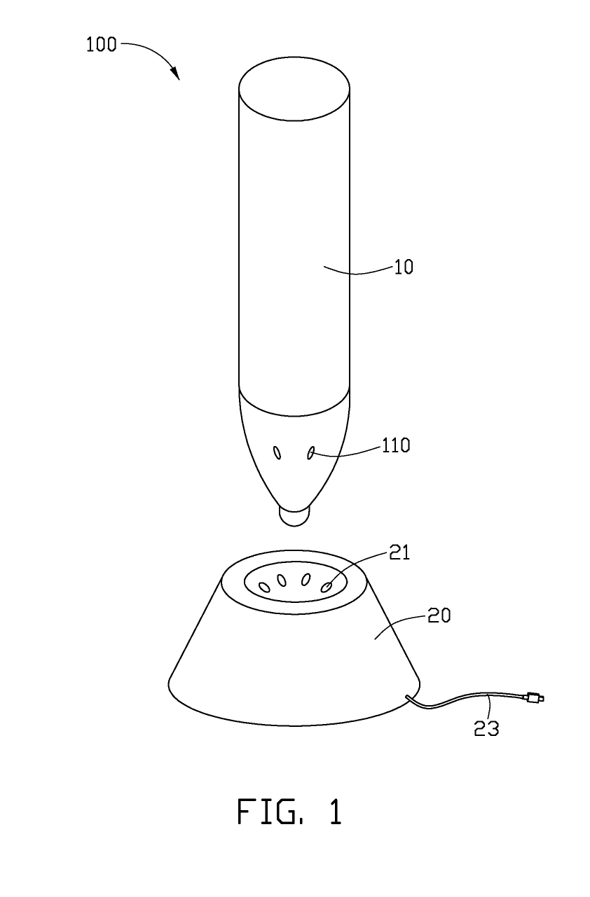

Referring to FIG. 1, an embodiment of a handwriting input device 100 is illustrated. The device 100 includes a handwriting pen 10 and a charger 20. The charger 20 can be connected to an external electronic device, for example, a computer. When the handwriting pen 10 is inserted into the charger 20, and the charger 20 is connected to the external electronic device, the handwriting pen 10 can obtain power from the external electronic device through the charger 20. Furthermore, while charging the handwriting pen 10 through the charger 20, the handwriting pen 10 can generate cursor control signals to control movement of a cursor displayed on the external electronic device or generate track control signals to control the external electronic device to display the track of the movement of the displayed cursor when the charger 20 is moved.

In this embodiment, the charger 20 is hollow. The charger 20 includes a number of first contacts 21 and a connecting unit 23. The first contacts 21 are electrically connected to a circuit board (not shown) of the charger 20. In this embodiment, the connecting unit 23 is a USB interface. The charger 20 is connected to the external electronic device through the connecting unit 23.

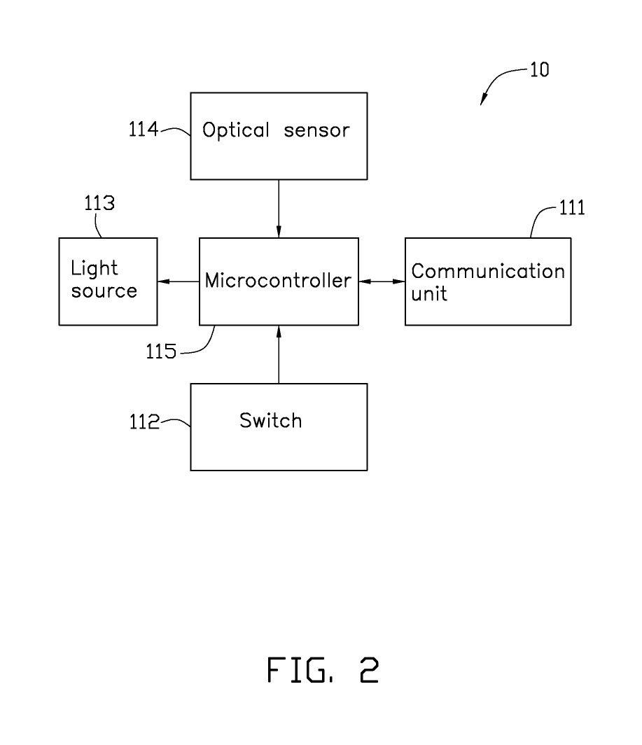

Referring to FIG. 2, the handwriting pen 10 includes a number of second contacts 110, a communication unit 111, a switch 112, a light source 113, an optical sensor 114, and a microcontroller 115. The second contacts 110 are exposed to the handwriting pen 10 and electrically connected to a circuit board (not shown) of the handwriting pen 10. The number of the second contacts 110 is equal to that of the first contacts 21. When the handwriting pen 10 is inserted into the charger 20 to cause each second contact 110 to be contacted with one of the first contacts 21, the handwriting pen 10 can be charged by the charger 20. In this embodiment, the second contacts 110 are arranged around an axis of the handwriting pen 10. The handwriting pen 10 communicates with the external electronic device through the communication unit 111. In this embodiment, the communication unit 111 may include any one or more of a BLUETOOTH unit, an infrared unit, a USB interface, and a WIFI unit, for example. The switch 112 is to switch the handwriting pen 10 between a handwriting mode and a cursor control mode. In the handwriting mode, the handwriting pen 10 can generate the track control signals to direct the handwriting pen 10 to display the track of the movement of the cursor. In the cursor control mode, the handwriting pen 10 can generate the cursor control signal to control the movement of the cursor.

The light from the light source 113 lights any reflective surface. The light source 113 can be laser or an LED. The optical sensor 114 converts the light reflected from any reflective surface to electrical signals.

The microcontroller 115 generates the cursor control signals according to the electrical signals from the optical sensor 114 in the cursor control mode, and transmits the cursor control signals to the external electronic device to direct the external electronic device to move the displayed cursor. The microcontroller 115 further generates the track control signals according to the electrical signals from the optical sensor 114 in the handwriting mode, and transmits the track control signals to the external electronic device to direct the external electronic device to display the track of the movement of the displayed cursor.

In this embodiment, when the charger 20 is connected to the external electronic device, and the handwriting pen 10 is inserted into the charger 20 to cause each second contact 110 to be contacted with one of the first contacts 21, the handwriting pen 10 can obtain power from the external electronic device through the charger 20. When the handwriting pen 10 is inserted into the charger 20, the light from the light source 113 lights a reflective surface under the charger 20. When the charger 20 is moved, the handwriting pen 10 is correspondingly moved and charged. While the handwriting pen 10 is being moved, the optical sensor 114 converts the light reflected from the reflective surface under the charger 20 into electrical signals. The microcontroller 115 generates the cursor control signals according to the electrical signals in the cursor control mode, or generates the track control signals according to the electrical signals in the handwriting mode.

In this embodiment, the handwriting pen 10 can be charged through the charger 20. Furthermore, while charging the handwriting pen 10, the handwriting pen 10 can be employed to control the movement of the displayed cursor or control the external electronic device to display the track of the movement of the displayed cursor through moving the charger 20. As the charger 20 is adapted for a user to hold and move, the handwriting pen 10 can be convenient to control the external electronic device through moving the charger 20.

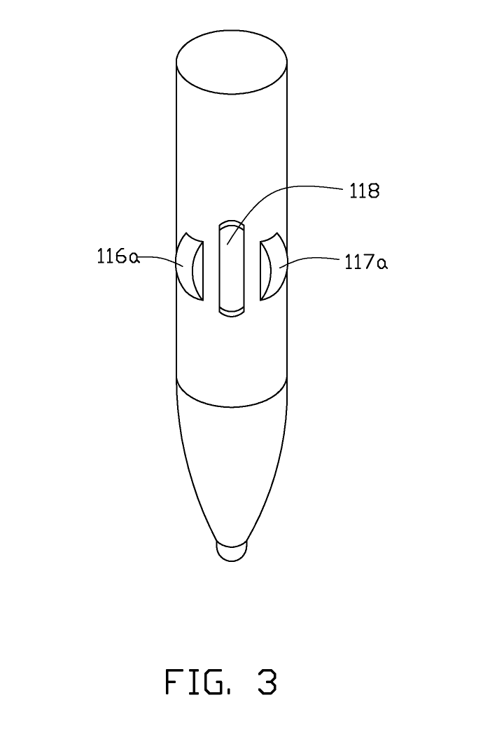

FIG. 3 shows that the handwriting pen 10 is employed as a mouse in a first embodiment. The handwriting pen 10 includes a first button 116a, a second button 117a, and a roller 118, all of which are electrically connected to the microcontroller 115 and are exposed outside the handwriting pen 10 for operation. The function of the first button 116a is similar to the function of a left button of a standard mouse, the function of the second button 117a is similar to the function of a right button of a standard mouse, and the function of the roller 118 is similar to the function of a roller of a standard mouse.

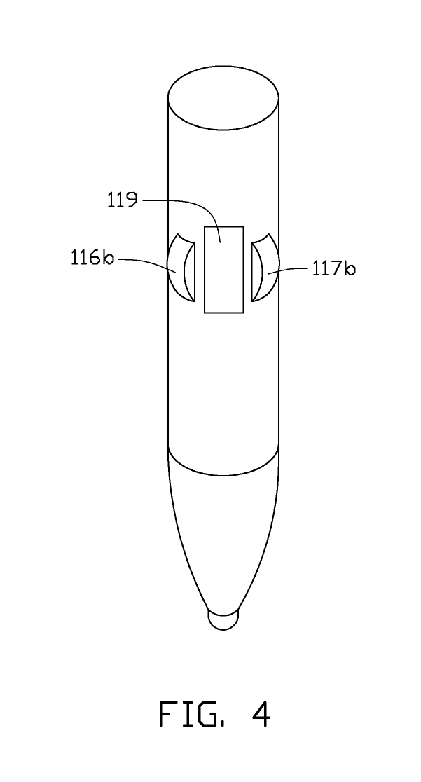

FIG. 4 shows that the handwriting pen 100 is employed as a mouse in a second embodiment. The handwriting pen 10 includes a first button 116b, a second button 117b, and a touch pad 119, all of which are electrically connected to the microcontroller 115 and are exposed outside the handwriting pen 10 for operation. The function of the first button 116b is similar to the function of a left button of a standard mouse, the function of the second button 117b is similar to the function of a right button of a standard mouse, and the function of the touch pad 119 is similar to the function of a roller of a standard mouse.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A handwriting input device comprising:
a charger being hollow and comprising a plurality of first contacts and a connecting unit, the connecting unit being to connect the charger to an external electronic device; and
a handwriting pen comprising:
a plurality of second contacts;
a communication unit to communicate the handwriting pen with the external electronic device connected to the charger;
a switch button to switch the handwriting pen between a cursor control mode and a handwriting mode;
a light source to emit light;
an optical sensor to convert reflected light into electrical signals; and
a microcontroller to generate cursor control signals according to the electrical signals from the optical sensor when the handwriting pen is in the cursor control mode or generate track control signals according to the electrical signals from the optical sensor when the handwriting pen is in the handwriting mode, and transmit the cursor control signals or the track control signals to the external electronic device communicating with the handwriting pen through the communication unit;
wherein, when the charger is connected to the external electronic device through the connecting unit, and the handwriting pen is inserted into the charger to cause each of the second contacts to be contacted with one of the first contacts, the handwriting pen is capable of obtaining power from the external electronic device, and when the charger is moved, together with the handwriting pen being charged, the optical sensor converts the light reflected from a reflective surface under the charger into the electrical signals, and the microcontroller generates the cursor control signals or the track control signals and transmits the cursor control signals or the track control signals to the external electronic device when the charger is moved.

2. The handwriting input device as described in claim 1, wherein the number of the first contacts is equal to that of the second contacts.

3. The handwriting input device as described in claim 1, wherein the second contacts are exposed to the handwriting pen and arranged around an axis of the handwriting pen.

4. The handwriting input device as described in claim 1, wherein the light source is laser.

5. The handwriting input device as described in claim 1, wherein the connecting unit is a USB interface.

6. The handwriting input device as described in claim 1, wherein the communication unit comprises at least one unit selected from the group consisting of a BLUETOOTH unit, an infrared unit, a USB interface, and a WIFI unit.

7. The handwriting input device as described in claim 1, wherein the handwriting pen further comprises a first button and a second button exposed to the handwriting pen and electrically connected to the microcontroller.

8. The handwriting input device as described in claim 7, wherein the handwriting pen further comprises a roller or a touch pad exposed to the handwriting pen and electrically connected to the microcontroller.
